(19) United States
(12) Patent Application Publication
(10) Pub. No.: US 2010/0023400 A1
(43) Pub. Date: Jan. 28, 2010

(54) Image Recognition Authentication and Advertising System

(76) Inventor: Timothy R DeWitt, Annapolis, MD (US)

Correspondence Address: 24IP LAW GROUP USA, PLLC, 12 E. LAKE DRIVE, ANNAPOLIS, MD, 21403, US

(21) Appl. No.: 12/572,717

(22) Filed: Oct. 2, 2009

Related U.S. Application Data
(63) Continuation of application No. 11/837,117, filed on Aug. 10, 2007, now abandoned.
(60) Provisional application No. 60/822,218, filed on Aug. 11, 2006.

(51) Int. Cl. G06Q 20/00; G06Q 30/00; G06Q 10/00; G06Q 40/00; H04N 5/225; G06F 7/04; G06F 17/30

(52) U.S. Cl. 705/14.53; 705/14.65; 705/17; 705/30; 705/44; 348/207.99; 340/5.83; 348/E05.024; 707/3; 707/102; 707/E17.014; 707/E17.02

(57) ABSTRACT

A system for authenticating a purchaser, collecting data of purchasers, and displaying personalized advertisements. The system uses video cameras to capture an initial image of the customer upon entry and/or at the register prior to checkout. The image is then sent via LAN or wireless LAN to a computer with image recognition software. The computer is connected to a credit card reader and to an in-store database where it can then be checked for a matching image. The database will then choose from a pool of advertisements to find one that matches the current customers shopping habits most accurately. The advertisement will then be projected onto a monitor in the customer's field of vision. At checkout, if the customer pays with a credit card, the information on the card will be sent to the computer where it will also be checked for a match in the database. The in-store database is connected with a larger central database which shares all recorded information with all stores.

### CROSS-REFERENCE TO RELATED APPLICATIONS

The present application is a continuation of U.S. patent application Ser. No. 11/837,117 and claims priority to and the benefit of that application. U.S. patent application Ser. No. 11/837,117 in turns claims the benefit of the filing date of U.S. Provisional Application Ser. No. 60/822,218 entitled “Image Recognition Authentication and Advertising System” and filed on Aug. 11, 2006.

The above cross-referenced related applications are hereby incorporated by reference herein in their entirety.

### STATEMENT REGARDING FEDERALLY SPONSORED RESEARCH OR DEVELOPMENT

None.

### BACKGROUND OF THE INVENTION

1. Field of the Invention

The present invention relates to authentication of persons purchasing items in retail establishments, collection of data associated with such purchases, and personalization of advertising based upon collected data of a purchaser.

2. Brief Description of the Related Art

In the present era of homeland security, facial image recognition has become a focus of progress in the government security industry. Many companies and individuals have presented systems and methods for performing facial image recognition and improving the accuracy and speed of such systems. Examples of such efforts to perform and improve facial image recognition systems include the systems and methods disclosed in U.S. Patent Application Publication No. US2006/0104504 entitled “Face Recognition Method and Apparatus,” No. US2006/0082439 entitled “Distributed Stand-Off ID Verification Compatible with Multiple Face Recognition Systems (FRS),” No. US2006/0062435 A1 entitled “Image Processing Device, Image Processing Method and Image Processing Program,” No. US2006/0034517 entitled “Method and Apparatus for Face Description and Recognition,” No. US2005/0276452 A1 entitled “2-D to 3-D Facial Recognition System,” and No. US2004/0151349 entitled “Method and Apparatus to Perform Automated Facial Recognition and Comparison Using Multiple 2D Facial Images Parsed from a Captured 3D Facial Image.”

Many patents and patent applications are directed to the use of facial image recognition in authenticating a person's identification or identifying persons of interest. An example of such a system is disclosed in U.S. Patent Application Publication No. US2006/0020630 A1, entitled “Facial Database Methods and Systems.” In that application, the inventors disclose various arrangements for use of biometric data. For example, a police officer may capture image data from a driver license (e.g., by using a camera cell phone). Facial recognition vectors are derived from the captured image data corresponding to photo on the license, and compared against a watch list. In another arrangement, a watch list of facial image data is compiled from a number of government and private sources. This consolidated database is then made available as a resource against which facial information from various sources can be checked. In still another arrangement, entities that issue photo ID credentials check each newly-captured facial portrait against a consolidated watch list database, to identify persons of interest. In yet another arrangement, existing catalogs of facial images that are maintained by such entities are checked for possible matches between cataloged faces, and faces in the consolidated watch list database. Other examples include U.S. Patent Application Publication No. US2004/0062423 A1 entitled “Personal Authentication Apparatus and Personal Authentication Method,” No. US2006/0136743 entitled “System and Method for Performing Security Access Control Based on Modified Biometric Data,” and No. US2006/0133652 A1 entitled “Authentication Apparatus and Authentication Method.” While such systems may have proved useful in the field of government security, they have not been appreciable applied to the commercial sector.

At the same time, the retail sales industry has begun to understand the usefulness of tracking a customer's purchases for purpose of marketing, advertising and making a variety of business decisions. Retail establishments often provide customers with frequent shopper cards or “bonus cards” in exchange for customers providing various personal data, such as their name, address and telephone number to the retail establishment. To encourage customers to provide such data, the retail establishments often provide the customers with sale prices, discounts, rebates, prizes or other types of rewards for purchasing items from the establishment. Such systems have proved useful, but often are burdensome for customers who must either carry the reward card with them or must enter some type of data, such as a telephone number, into the retail establishment's system at the time of each purchase. Further, the systems suffer from many limitations, from being completely reliant upon a customer entering correct data into the system, providing correct data at the time of registering for the reward program, and being unable to identify a customer prior to their actual checkout. Such systems also lack any ability to assist retail establishments in combating problems such as credit card and/or check fraud.

### SUMMARY OF THE INVENTION

In accordance with the present invention, stores may use image recognition to identify a customer in real time, for example, as they enter the store or as they step to the register to make a purchase. This image may then be compared with a database to identify the personal shopping habits of the customer in order to use more specific advertisement strategies. Image recognition may also be used to aide in the identification of a customer in the case of, for example, payment by credit card or check.

The present invention utilizes real time image recognition to associate a digitized image of a customer with credit card information in order to circumvent a manual identification check or to generate customer specific advertisements. Revenue loss due to credit card or check fraud and identity theft is on the rise, and with the only means of prevention (manual identification check) being time consuming, there is a need for a solution. The present invention can not only greatly reduce loss due to credit card or check fraud, but it can also speed up routine transactions and make for an overall better shopping experience for the customer.

When the system is implemented, a database is generated over time to correlate facial images to information such as a credit card numbers, bank account numbers, or shopping habit data. Other information may similarly be correlated to the facial images. The database may be used to authenticate a customer, for example, attempting to pay by credit card. The authentication is performed by generating a current digital facial image of the customer and inputting information of the credit card the customer seeks to use. The current image and the credit card data each are compared to the database to determine whether the customer previously has been entered into the system and/or whether the credit card data previously has been entered into the database. If a match of either or both the image and credit card data are found in the database, the system performs one or more comparisons of the current data with the data in the database to confirm the identify of the customer.

Once the database is generated, another embodiment of the invention uses video cameras to capture an initial image of the customer upon entry and/or at the register prior to checkout. The image is then sent via LAN, wireless LAN, or any other means for communication between electronic components to a computer, CPU or processor with image recognition software. The computer is connected to a credit card reader and to a database, which in one preferred embodiment is an in-store database, where it can then be checked for a matching image. While a credit card reader is used in a preferred embodiment, credit or other financial information may be entered by other means, such as by other electronic means or even by manually inputting the information.

In a further preferred embodiment of the present invention, the computer will then choose from a pool of advertisements to find one that matches the current customer's shopping habits most accurately. The advertisement will then be projected onto a monitor in the customer's field of vision. At checkout, if the customer pays with a credit card, the information on the card will be sent to the computer where it will also be checked for a match in the database. The in-store database may be connected with a larger central database which shares all recorded information with all stores. In alternative embodiments, the database may be located in a different location rather than being an in-store database.

In a preferred embodiment, the present invention is method for authenticating a purchaser comprising the steps of acquiring an image associated with the purchaser, digitizing the image, adding the digitized image to database, inputting financial data associated with the purchaser; and adding the financial data to the database and associating the financial data with the image of the purchaser. The acquired image may comprise, for example, a facial image or a fingerprint. The method may further comprise adding purchase data associated with the purchaser to the database and associating the purchase data with the acquired image. The financial data may comprise credit card data, debit card data, check data, or any other financial data.

In another embodiment, the present invention is a method for authenticating a customer comprising the steps of acquiring an image associated with the customer, digitizing the acquired image, comparing the digitized acquired image to digitized images in a database, inputting financial data associated with the customer, if the comparing step results in a matching image being found in the database, comparing the inputted financial data to financial data in the database associated with the matching image, if the inputted financial data matches the financial data associated with the matching image in the database, approving a transaction with the customer. The steps need not be performed in this exact sequence, as other sequences of these steps will be apparent to those of skill in the art. The method may further comprise the steps of adding the acquired image to the database if no matching image is found in the database and requesting a manual identity verification. The method may further comprising the step of adding the financial data to the database and associated the financial data with the acquired image in the database if the customer's identity is manually verified. Still further, if the customer's identity is not manually verified, the acquired image may be flagged in the database for increased security measures in connection with future purchases.

In yet another embodiment, the method may further comprise the steps of inputting current purchase data; and associating the current purchase data with the matching image in the database.

In still another embodiment, the method according to the present invention further comprises the step of adding the acquired image to the database when a matching image is found and associating the acquired image in the database with all matching images in the database. The acquired image may further be associated in the database with all financial data associated with any matching image in the database and any purchase data associated with any matching image in the database.

In another embodiment, the present invention further comprises the step of selecting an advertisement based upon purchase data associated with the matching image in the database. The selected advertisement may be displayed on a monitor in the customer's field of vision. A general advertisement may be displayed on a monitor in the customer's field of vision if no matching image is found in the database or a specific advertisement may be displayed in a match is found. An advertisement that best matches data of previous purchases of the customer may be selected from a queue of advertisements.

In another embodiment, the present invention is an apparatus that comprises an image acquisition device, a financial data input device, a computer connected to the image acquisition device and the financial data input device, and storage means connected to the computer for storing images and financial data associated with the images. The image acquisition device may comprise, for example, a camera, a video camera, or a fingerprint scanner.

Still other aspects, features, and advantages of the present invention are readily apparent from the following detailed description, simply by illustrating a preferable embodiments and implementations. The present invention is also capable of other and different embodiments and its several details can be modified in various obvious respects, all without departing from the spirit and scope of the present invention. Accordingly, the drawings and descriptions are to be regarded as illustrative in nature, and not as restrictive. Additional objects and advantages of the invention will be set forth in part in the description which follows and in part will be obvious from the description, or may be learned by practice of the invention.

### BRIEF DESCRIPTION OF THE DRAWINGS

For a more complete understanding of the present invention and the advantages thereof, reference is now made to the following description and the accompanying drawings, in which:

FIG. 1 is a flow chart illustrating a method for authentication and data collection in accordance with a preferred embodiment of the present invention.

FIG. 2 is a flow chart illustrating a comparison of a method of selecting an advertisement in accordance with a preferred embodiment of the present invention.

FIG. 3 is a flow chart illustrating a comparison of a method for authentication and data collection in accordance with a preferred embodiment of the present invention.

FIG. 4 is a flow chart illustrating a comparison of a method for authentication and data collection in accordance with a preferred embodiment of the present invention.

FIG. 5 is a diagram illustrating a system for taking, retrieving, and storing digitized images and credit card information in accordance with a preferred embodiment of the present invention.

FIG. 6 is a diagram illustrating a more specific system for taking, retrieving, and storing digitized images and credit card information at the checkout phase in accordance with a preferred embodiment of the present invention.

FIG. 7 is a diagram illustrating a system for linking all in-store databases to one large central database in accordance with a preferred embodiment of the present invention.

FIG. 8 is a diagram illustrating a more specific system for taking, retrieving, and storing digitized images and credit card information upon entry of the store in accordance with a preferred embodiment of the present invention.

### DETAILED DESCRIPTION OF THE PREFERRED EMBODIMENTS

The present invention may applied to many different environments and incorporate many different features or functionalities. A system of the present invention uses authentication techniques to identify an individual and then uses that information in a variety of ways to reduce criminal acts such as credit card or check fraud by such individuals and/or to improve the shopping experience of such individuals through personalization. Preferably, the system uses facial image recognition because such a system is passive in the sense that the individual being identified or authenticated need not even know the system exists. While facial image recognition is preferred, the invention also may be implemented with other authentication techniques such as fingerprint recognition.

In a preferred embodiment the system has a database that evolves over time as the system is used. Data is entered into the database, for example, each time an individual makes a purchase at an establishment using the system. The data preferably would include an image (such as facial or fingerprint) of an individual, credit card data (names, numbers, etc.), and shopping habit data. Through the following description, embodiments are described with respect to facial images due to the passivity of such systems, but such embodiments likewise could be implemented using other identification or authentication techniques such as fingerprint recognition. When an individual makes a purchase, the image of the individual is added to the database along with any other information such as a credit card or bank account number and data of the customer's current purchase. If the individual's image has not previously been entered into the system, a manual identity check such as viewing a passport or driver's license is performed. If the person's image previously was entered into the system, the person's identity can be verified through the various image and data comparisons without any manual identification check.

A preferred embodiment of the present invention is described herein by way of example with respect to a sporting goods store. Those of skill in the art will understanding applications of the present invention in many other environments. Upon entry, the customer is already subject to constant surveillance for security reasons. In real time, the invention may use these same cameras or other cameras to capture an initial image which will be digitized and sent via LAN or wireless LAN to a computer where it will then be compared with a database of images. If a positive match is found, the computer will then search the database for the purchase history of the customer and determine the most suitable advertisement in the queue of advertisements. This advertisement will then be moved into the first position in the queue and be displayed on an advertisement monitor in the customer's field of vision. For example, if the customer bought a golf club in the past, an advertisement for a sale on golf balls and their location within the store might be the most suitable advertisement for the customer and will thus be displayed next on the advertisement monitor. This process may be done at any location in the store as long as there is an advertisement monitor in the customer's field of vision. An image of the customer may also be taken at the register during checkout and the same process may be applied.

If the customer uses a credit card to purchase any items, the computer will search the database for a previous use of the credit card by the same customer. If a match is found, the clerk need not manually check the customer's ID since this was done for a previous purchase and found to be authentic. This will help to speed up the transaction, cut down on human error on the clerk's behalf in positively confirming the identification of the customer, and make for a better overall shopping experience for the customer. This will also eliminate the need for all bonus or frequent shopper cards since the purchase history of all customers will be automatically recorded. Alternatively, if there is no match or if there is a discrepancy between the credit card and the information in the database, the computer will display a message to the clerk and the clerk will manually authenticate the credit card and the image, the credit card data, and the purchase history will be added to the database for future use. In the case of a customer unlawfully using a stolen credit card, the customer's image and the credit card information will be flagged for possible notification of law enforcement. This security embodiment of the invention may be implemented separate from or together with the advertising embodiment in the preceding paragraph and vice versa.

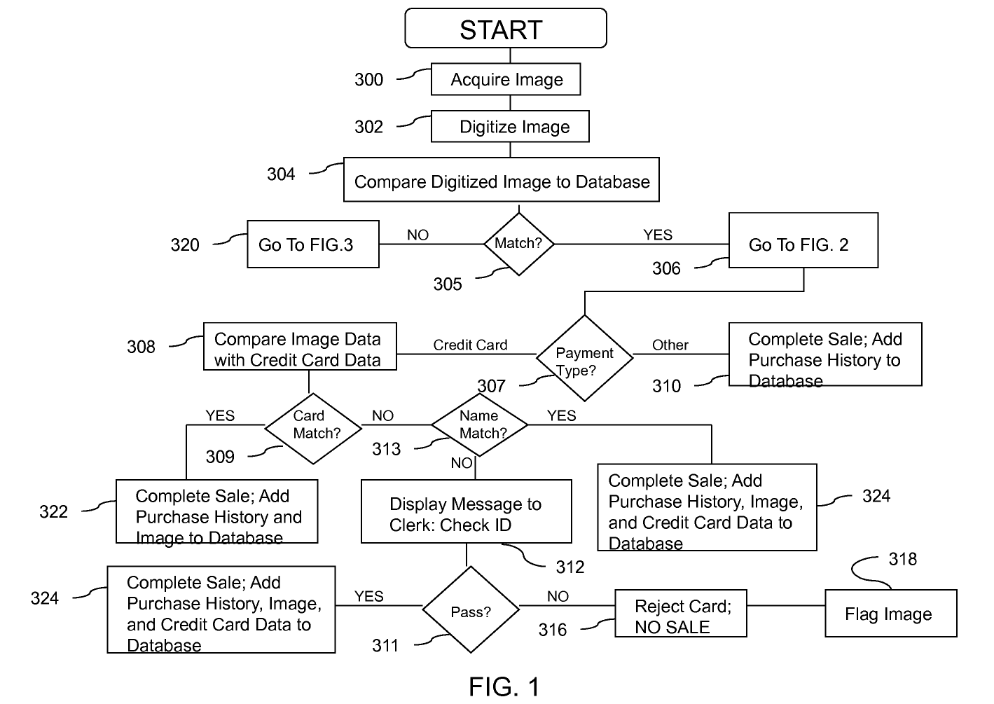

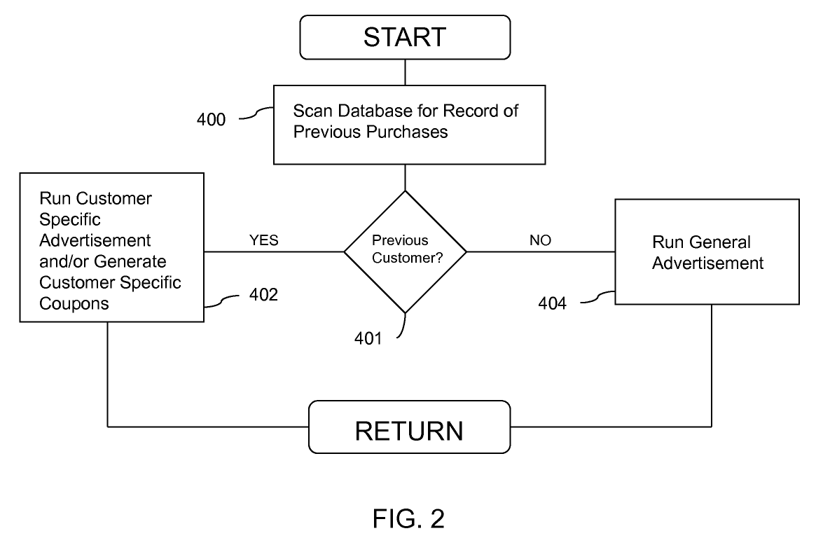

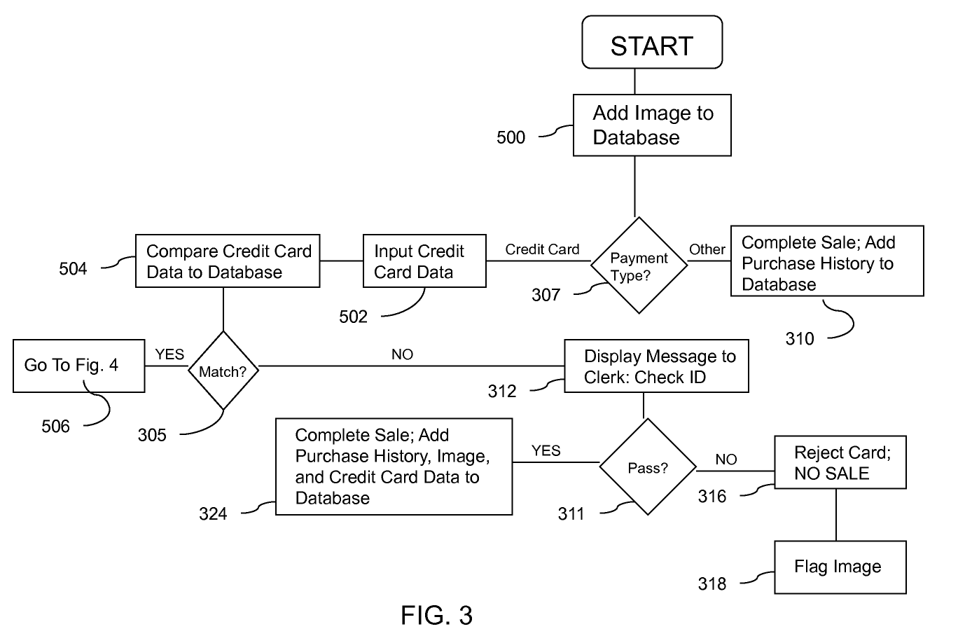

A method of performing authentication, collecting data, and selecting personalized advertisements in accordance with a preferred embodiment of the present invention is described with reference FIGS. 1-4. An image is acquired 300, for example, upon entry to the store or upon checkout. The image is then digitized 302, and the digitized image is compared to a database 304. The system then looks for a match 305. If there is no match 320, the system may perform the steps in FIG. 3. If there is a match 306, the system may perform the steps in FIG. 2. After the steps of FIG. 2 are run, in an embodiment incorporating those steps, the system then determines payment type 307. In this embodiment, if the customer uses a method of payment that is not a credit card, the system completes the sale and adds purchase history to the database 310. In other embodiments, authentication may be implemented with respect to purchases by means other than credit cards, such as by check or by debit card. Continuing with reference to FIG. 1, if the customer pays with a credit card, the system compares the digitized image data with card data in the database 308. The system then determines if the card matches the image 309. If there is a match, the system completes the sale and adds purchase history and the image to the database 322. If there is not a match, the system determines if the name on the credit card matches 307. If there is a match, the system completes the sale and adds purchase history, the image, and the credit card data to the database 324. If there is not a match, the system displays a message to the clerk to check the customer's ID 312. The clerk then determines if the ID passes 311. If the clerk inputs a positive match (referred to here as a “yes” entry) the system completes the sale and adds purchase history, the image, and the credit card data to the database 324. If the clerk inputs no match (referred to herein as a “no” entry) the card is rejected, there is no sale 316, and the system flags the image 318 in the database.

FIG. 2 is a flow chart of a plurality of steps that may be implemented together with FIG. 1. The system scans the database for the record of previous purchases 400 by the customer and then determines if the current customer is a previous customer 401. If the customer is recognized as having made previous purchases, the system may run customer specific advertisements on the advertisement monitor behind the counter and/or generate customer specific coupons. If the customer is not recognized as having made previous purchases, the system may run a general advertisement or no advertisement on the advertisement monitor behind the counter. As noted previously, this advertisement portion of the invention need not be used together with the authentication portions of the invention and vice versa.

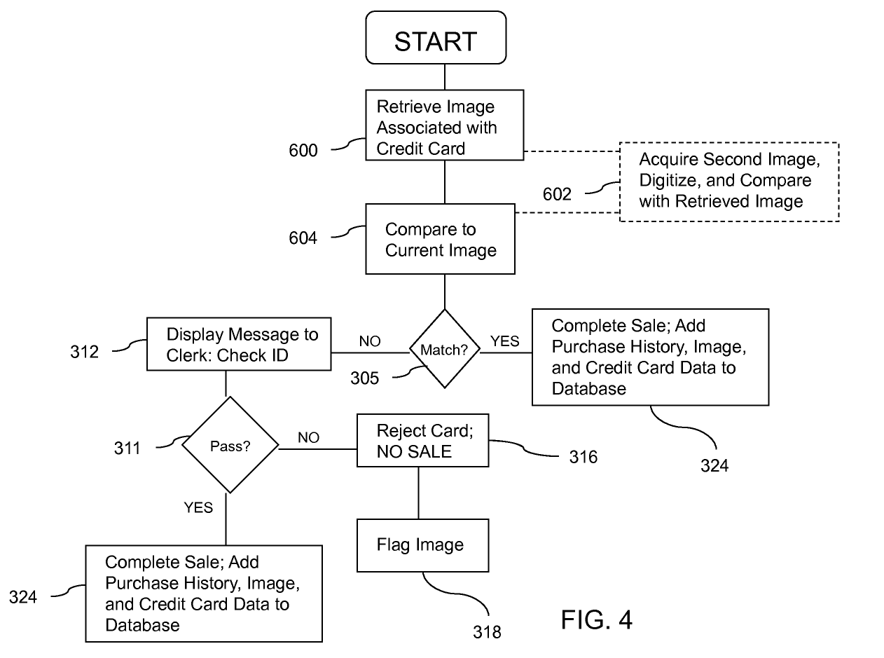

FIG. 3 is a flow chart of a plurality of steps that may be performed together with FIG. 1. The system adds the digitized image to the database 500. The system then determines payment type 307. If the customer uses a method of payment that is not a credit card, the system completes the sale and adds purchase history to the database 310. If the customer pays with a credit card or other means that can be associated with the customer, the system inputs the credit card or other data 502 and compares the credit card or other data to the database 504. The system then looks for a match 305. If there is a match 506, the system may perform the steps in FIG. 4. If there is no match, the system displays a message to the clerk to check the customer's ID 312. The clerk then determines if the ID passes 311 and types yes or no into the system. If the clerk enters “yes” the system completes the sale and adds purchase history, the image, and the credit card data to the database 324. If the clerk enters “no” the card is rejected and there is no sale 316 and the system flags the image 318.

FIG. 4 is a flow chart of steps that may be performed in conjunction with FIGS. 1 and/or 3. The system retrieves the image associated with the credit card 600 and compares the retrieved image to the current image 604. Additionally the system may acquire a second image, digitize it, and compare it with the retrieved image 602. The system then looks for a match 305. If there is a match, the system completes the sale and adds purchase history, the image, and the credit card data to the database 324. If there is not a match, the system displays a message to the clerk to check the customer's ID 312. The clerk then determines if the ID passes 311 and types yes or no into the system. If the clerk enters “yes” the system completes the sale and adds purchase history, the image, and the credit card data to the database 324. If the clerk enters “no” the card is rejected and there is no sale 316 and the system flags the image 318.

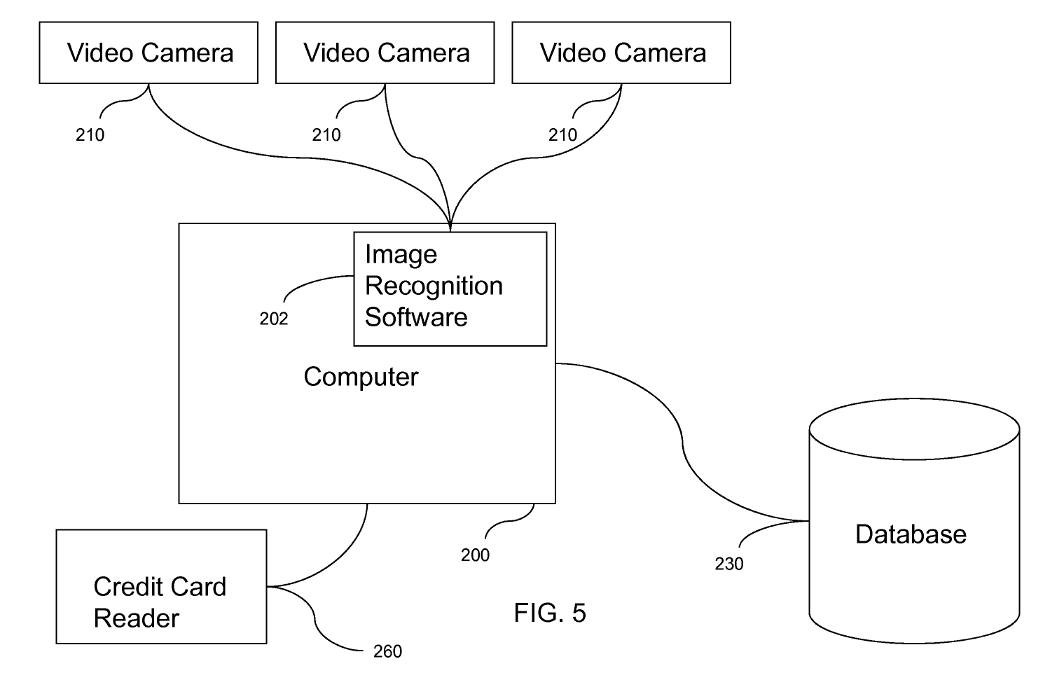

FIG. 5 is a diagram in which an image is acquired from video camera 210 and sent to a computer 200 that contains image recognition software 202. The image is then compared to all images on in-store database 230. If the customer swipes a credit card at credit card reader 260, the information travels to computer 200 and is compared to all credit card information on in-store database 230.

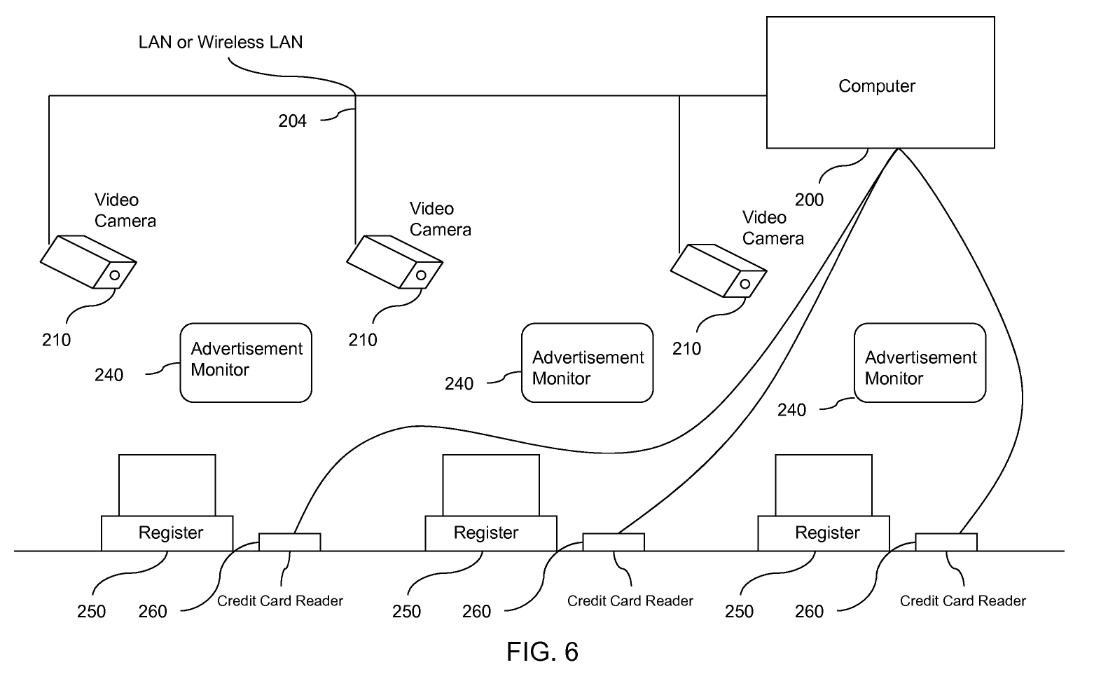

FIG. 6 is a more accurate and alternative view of the process in FIG. 1 in which the video cameras 210 acquire an image of the customer in front of the registers 250. The image is then sent via LAN or wireless LAN 204 to computer 200 and is compared with all images on in-store database 230 (not shown). If a match is found, a customer specific advertisement will be displayed on advertisement monitor 240. If no match is found, a random advertisement will be displayed instead. If the customer swipes a credit card at credit card reader 260, the information travels to computer 200 and is compared to all credit card information on in-store database 230.

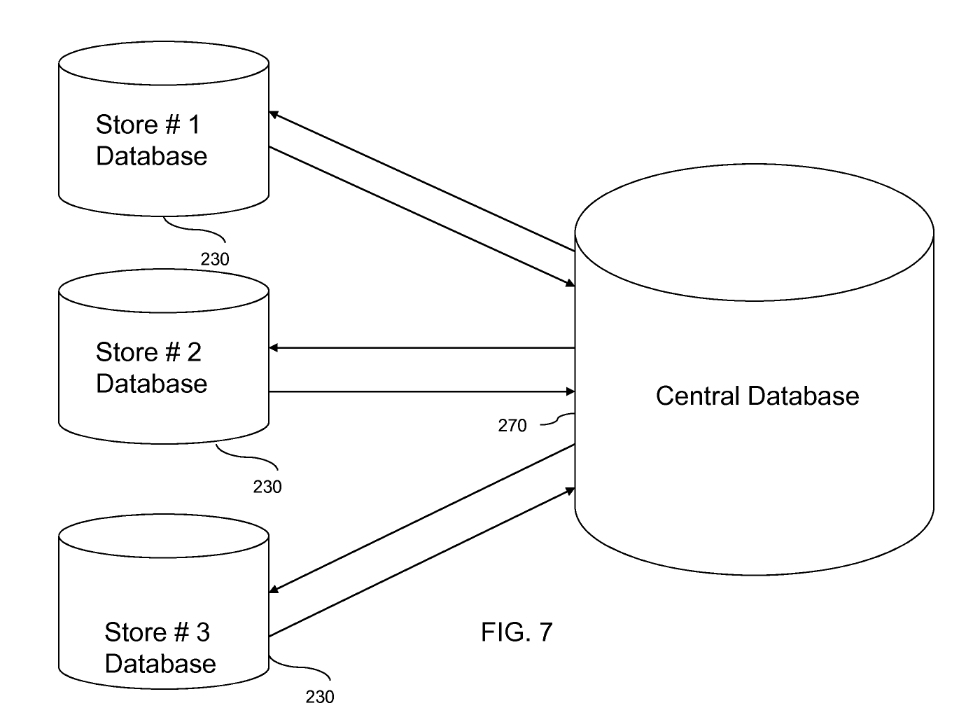

FIG. 7 is a diagram showing the connection between all in-store databases 230 and the central database 270 for all images and credit card information to be securely shared between all stores in the chain.

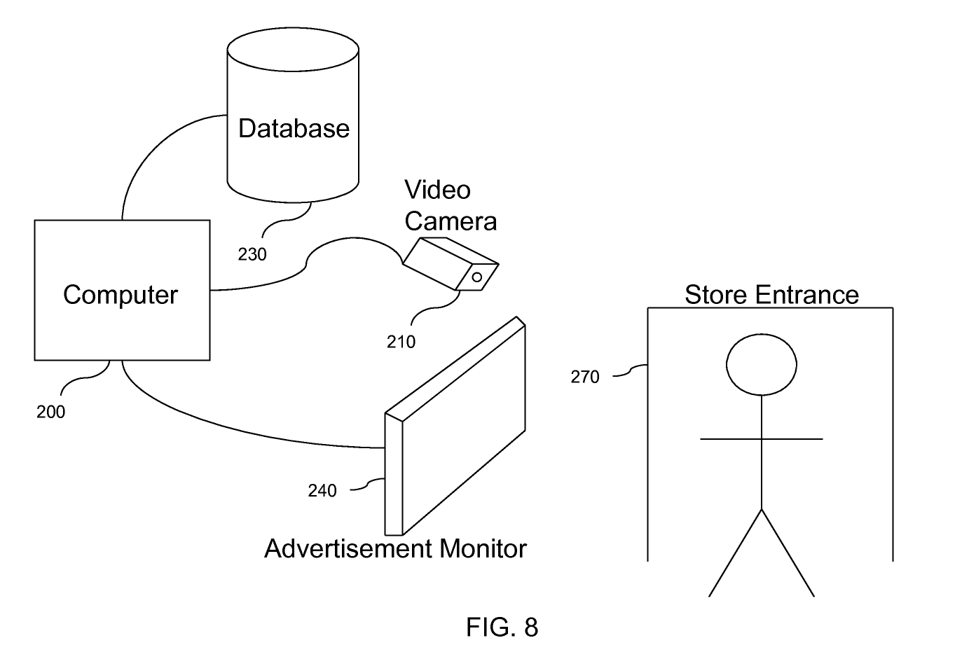

FIG. 8 is a diagram showing an alternative use for the patent in which the initial image is acquired by video camera 210 at the store entrance 270 upon the entry of the customer. The image is then sent to computer 200 and is compared with all images on in-store database 230. If a match is found, a customer specific advertisement will be displayed on advertisement monitor 240. If no match is found, a random advertisement will be displayed instead.

The foregoing description of the preferred embodiment of the invention has been presented for purposes of illustration and description. It is not intended to be exhaustive or to limit the invention to the precise form disclosed, and modifications and variations are possible in light of the above teachings or may be acquired from practice of the invention. The embodiment was chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

What is claimed is:

1. A system for authenticating a current customer comprising the steps of:
an image acquisition device for acquiring an image associated with said current customer;
an input device for inputting financial data associated with said current customer;
storage means;
a database stored in said storage means, said database comprising customer images acquired during prior purchases and associated customer financial data inputted in connection with prior purchases;
a processor connected to said image acquisition device, said input device and storage means, said processor comprising:
means for adding said acquired image associated with said current customer to said database;
means for adding said financial data to said database and associating said financial data with said image of said current customer;
means for comparing said acquired image to a plurality of images stored in said database of customer images, wherein said plurality of images are associated with a plurality of customers;
means for comparing inputted financial information with customer financial data associated with a matching image when said means for comparing identifies a matching image in said database; and
means for approving a transaction when said means for comparing an acquired image identifies a matching image and said means for comparing inputted financial information identifies matching financial information; and
a display connected to said processor, wherein said processor displays on said display a message requesting manual identity verification when either of said comparing means fails to find a match.

2. A system according to claim 1 wherein said image acquisition device comprises a camera.

3. A system according to claim 1 wherein said image acquisition device comprises a fingerprint scanner.

4. A system according to claim 1 wherein said input device comprises a credit card scanner.

5. A system according to claim 1 further comprising a second input device connected to said processor for inputting purchase data associated with said customer, wherein said processor stores purchase data inputted through said second input device to said database and associates said purchase data with said image of said current customer in said database.

6. A system for authenticating a customer comprising:
a digital camera for acquiring an image associated with said customer;
means for comparing said acquired image to a plurality of images in said database to identify an image in said database that matches said acquired image, wherein said comparing is performed using only said digitized acquired image and said plurality of digitized images in said database and no external data associated with said customer and said database comprises images and financial data associated with said images acquired during prior transactions;
input means for inputting financial data associated with said customer;
means for comparing financial data from said input means to financial data in said database associated with said matching image;
means for approving a transaction with said customer if said financial data from said input means matches said financial data associated with said matching image in said database;
means for requesting manual identity verification when either of said comparing means fails to find a match.

7. A system according to claim 6, wherein said digital camera comprises a video camera.

8. A system according to claim 6, further comprising:
means for adding said acquired image to said database if no matching image is found in said database; and
means for requesting a manual identity verification.

9. A system according to claim 8, further comprising:
means for adding said financial data to said database and associating said financial data with said acquired image in said database if said customer's identity is manually verified; and
means for flagging said acquired image in said database for increased security measures in connection with future purchases if said customer's identity is not manually verified.

10. A system according to claim 6, further comprising:
input means for inputting current purchase data; and
means for associating said current purchase data with said matching image in said database.

11. A system according to claim 6 further comprising:
means for adding said acquired image to said database; and
means for associating said acquired image in said database with a plurality of matching images in said database.

12. A system according to claim 11 further comprising:
means for associating said acquired image in said database with all financial data associated with any matching image in said database.

13. A system according to claim 11 further comprising:
means for associating said acquired image in said database with all purchase data associated with any matching image in said database.

14. A system according to claim 6, further comprising:
means for selecting an advertisement based upon purchase data associated with said matching image in said database.

15. A system according to claim 14 further comprising:
a display for displaying said selected advertisement on a monitor in said customer's field of vision.

16. A system according to claim 14 wherein said means for selecting an advertisement comprises:
a queue of electronically stored advertisements; and
means for selecting an advertisement that best matches data of previous purchases of said customer.

17. A computer-implemented method for authenticating a purchaser comprising the steps of:
acquiring a digital image associated with said purchaser on an image acquisition device in a retail establishment;
passing said acquired image to a processor and said processor adding said acquired image to a database in a storage;
inputting financial data associated with said purchaser through an input device at said retail establishment and passing said inputted financial data to said processor and said processor adding said financial data to said database and associating said financial data with said acquired image of said purchaser;
comparing in said processor said acquired image to a plurality of images stored in said database, wherein said plurality of images are associated in said database with a plurality of customers;
if said image comparing step performed by said processor results in no matching image being found in said database, said processor requesting a manual identity verification;
if said image comparing step performed by said processor results in a matching image being found in said database, comparing in said processor said inputted financial data to financial data stored in said database associated with said matching image;
if said financial data comparing step performed by said processor results in matching financial data being found in said database, approving a transaction with said customer; and
if said financial data comparing step performed by said processor results in no match being found in said database, said processor displaying on a display a request for manual identity verification;
wherein if said manual identity verification is successful, said inputted financial data is added to said database and associated with both said acquired image and said matching image and if said manual identification is unsuccessful a transaction by said purchaser is denied.

18. A computer-implemented method according to claim 17, further comprising the step of said processor adding purchase data associated with said purchaser to said database and associating said purchase data with said acquired image and any matching images in said database.

19. A computer-implemented method according to claim 17, further wherein said comparing said acquired image is performed using only said digitized acquired image and said plurality of digitized images in said database and no external data associated with said customer.

20. A computer-implemented method according to claim 17, wherein if said customer's identity is not manually verified, said processor flagging said acquired image in said database in said storage for increased security measures in connection with future purchases.
